(19) United States
(12) Patent Application Publication
(10) Pub. No.: US 2013/0277021 A1
(43) Pub. Date: Oct. 24, 2013

(54) Cold Box Design for Core Replacement

(71) Applicant: Robert R. Huebel, Sugar Land, TX (US)

(72) Inventor: Robert R. Huebel, Sugar Land, TX (US)

(73) Assignee: Lummus Technology Inc.

(21) Appl. No.: 13/453,597

(22) Filed: Apr. 23, 2012

(51) Int. Cl. F28F 9/02; B23P 15/26

(52) U.S. Cl. 165/157; 29/890.035

(57) ABSTRACT

A cold box particularly for use in a LNG cryogenic processes in which a plurality of cores of heat exchanger units are mounted within a housing. Headers are positioned in the housing with feed lines connecting the headers to manifolds on the cores. The cores and headers are arranged such that no header is positioned to block the removal of any core through the front and/or back of the housing. A method of making the cold box is also disclosed.

### TECHNICAL FIELD

This application relates generally to a design for a cold box, and more particularly, to a cold box having a design that enhances core replacement.

### BACKGROUND

Hydrocarbon gases such as natural gas are liquefied by cryogenic processes to reduce their volume for easier transportation and storage. Brazed aluminum plate fin heat exchangers have been utilized in the cryogenic processing of natural gas and liquefied natural gas (LNG) for many years. Compared to conventional shell & tube exchangers, they offer many advantages, including smaller size and weight, and hence less cost.

The maximum size of a heat exchanger that can be fabricated is limited by the size of the manufacturer's brazing furnace. For large capacity facilities, multiple sections of heat exchanger units, referred to as “cores,” are fabricated and interconnected to form the complete heat exchanger. Where several of these cores are required, a cold box configuration is utilized, with the exchanger assembled within a structural steel framework (the box), with an insulation such as perlite filling the voids within the box for heat conservation. With such cold boxes, maintenance can often be an issue, requiring extended shutdown periods to accomplish the necessary repairs required. When the repair or replacement of a core is necessary, the current practice of interconnecting the cores within the cold box impedes maintenance.

The oil & gas industry is now considering offshore floating LNG (FLNG) production units. U.S. Pat. No. 6,250,244 describes a floatable natural gas liquefaction system using a series of heat exchangers. The heat exchangers can be arranged in a cold box.

Another example of an offshore production unit is shown in U.S. Pat. No. 6,889,522, issued May 10, 2005 to Prible et al., the disclosure of which is incorporated herein by reference in its entirety. U.S. Pat. No. 6,889,522 describes two nautical vessels to produce store and unload liquefied petroleum gas (LPG) and LNG. The first vessel is a LPG/FPSO (liquified petroleum gas/floating production, storage and offloading) vessel. The second is a LNG/FPSO vessel. Certain technology that has applicability for FLNG applications utilize units which operate at cryogenic temperatures and which will utilize cold boxes with cores of brazed aluminum heat exchangers. Examples of such technology include the processes shown and disclosed in U.S. Pat. No. 5,755,114, issued May 26, 1998 to Foglietta and U.S. Pat. No. 6,412,302, issued Jul. 2, 2002 to Foglietta. The disclosure of both these patents is incorporated herein by reference in its entirety.

One of the concerns with current designs of FLNG units is the high repair cost for cold boxes used therein. The space around the cold boxes is congested and access to the cold boxes is more difficult.

Another concern with current designs of cold boxes such as those configured for use in FLNG units is the cost associated with downtime. In a typical onshore installation of a LNG unit, the economic consequences of taking a unit off-line are relatively modest. Sometimes the feed gas can be diverted around the plant, minimizing impact to the customer. In contrast, the cost of downtime on an FLNG unit containing the cores in a cold box would be high. A typical FLNG unit will be designed to remain offshore for a period of 20+ years, without the need for dry-docking, meaning that any repair must be made onsite. Costs will include those incurred in moving components to and from the offshore unit, and in paying personnel to safely service the offshore unit. It is likely that FLNG units will be installed at remote locations, with no easy access by vendors/suppliers and repair staff.

It is thus desirable that a cold box be designed such that the cost of core repairs, and the amount of downtime required to complete the core repairs, is minimized.

### SUMMARY

According to one embodiment there is provided a cold box including a housing providing an enclosed structure and at least one set of a plurality of cores within the housing, each core having a front, back, top, bottom and side surface. The cores in each set are positioned in a row in front-to-back relationship along an axis, the cores having a plurality of manifolds on their front and back sides. A plurality of headers are provided within the housing and are configured to be connected to conduits outside of the housing The headers extend parallel to the axis of the row of cores. The headers are positioned to the top, bottom and/or rear of the heat exchange units with the space between one side of all the cores and the housing being free from the headers. Feed lines connect each of the headers to a respective manifold.

According to a further embodiment there is provided a cold box including a housing providing an enclosed structure including a front, back, two sides, a top and a bottom. A plurality of cores having front, top, bottom and two spaced side surfaces are within the housing positioned in a row in front-to-back relationship. A plurality of manifolds are provided on the front and back surfaces of each core. A plurality of headers are provided within the housing adapted to be connected to conduits outside of the housing. The headers extend parallel to the axis of the row of cores. The headers are positioned to the top, bottom and rear of the cores with the space between the one side of the cores and the front of the housing being free from the headers. Feed lines connect each of the headers to a respective manifold on the cores.

According to yet another embodiment, a cold box is provided including a housing providing an enclosed structure including a front, back, two sides, a top and a bottom. A plurality of cores having front, top, bottom and two spaced side surfaces are provided within the housing, the cores being positioned in two rows with the cores in each row being in front-to-back relationship. A plurality of manifolds are provided on the front and back surfaces of each core. A plurality of headers are provided within the housing adapted to be connected to conduits outside of the housing. The headers extend parallel to the axis of the row of cores. The headers are positioned to the top, bottom and between the rows of cores heat exchange units with the space between one side of each of the cores and the housing being free from the headers. Feed lines connect each of the headers to a respective manifold on the cores.

Another embodiment is a method of making a cold box, comprising obtaining a housing providing an enclosed structure with a removable side wall and disposing at least one set of a plurality of cores within the housing, each core having a front, back, top, bottom and side surface, the cores in each set positioned in a row in front-to-back relationship along an axis, the cores having a plurality of manifolds on their front and back sides. The method also includes disposing a plurality of headers within the housing, the headers being configured to be connected to conduits outside of the housing, the headers extending parallel to the axis of the row of cores, the headers being positioned to the top, bottom and/or rear of the cores with the space between one side of all the cores and the housing being free from the headers, and connecting each of the headers to a respective core using a feed line.

### BRIEF DESCRIPTION OF THE DRAWINGS

FIG. 1A is an isometric view of a prior art layout of a cold box with five cores and which is typical of the design for two up to five cores;

FIG. 1B is an isometric view of a prior art layout of a cold box with six cores and which is typical of the design for six or more cores;

FIG. 2A is an isometric view of a layout for a five core cold box according to one aspect of the disclosure and which would be similar for two up to five cores;

FIG. 2B is a view similar to FIG. 2A, but showing one of the cores in the process of being removed;

FIG. 2C is a view looking at the side of FIG. 2B;

FIG. 3A is an isometric view of a layout for a six core cold box according to another aspect of the present disclosure and which would be similar for six or more cores;

FIG. 3B is a view similar to FIG. 3A, but showing two of the cores in the process of being removed;

FIG. 3C is a view looking at the side of FIG. 3B;

FIG. 4A is an isometric view of a layout for a ten core cold box according to another aspect of the present disclosure; and

FIG. 4B is a view similar to FIG. 4A, but showing two of the cores in the process of being removed.

### DETAILED DESCRIPTION

The embodiments disclosed herein provide a new design for a cold box that has significantly lower maintenance and repair costs than a conventional cold box. In the embodiments described herein, the headers disposed in the cold box that lead to the cores are configured to permit easy removal of an individual core if repair or replacement becomes necessary with the cold box remaining in place. By facilitating repair and replacement, downtime is also reduced, providing additional advantages.

The goal of one who designs a floating heat exchange unit is to make the heat exchanger as small and lightweight as possible in order to minimize the footprint and buoyancy requirements of the floatation device that supports the unit. Along these lines, it has been an objective of various research and design projects to reduce the size and weight of equipment used on offshore platforms (see, for example, Offshore Engineer, December 2010, “Lighter topsides: the what, why and how” and Boyd, N. G. “Topsides Weight Reduction Design Techniques for Offshore Platforms,” Offshore Technology Conference, 5-8 May, 1986, Houston, Tex.). In contrast, the cold box design described herein moves in an opposite direction. More specifically, the new cold box is larger and/or heavier than units according to the previous design having the same capacity. Such a configuration clearly was not apparent to others at the time this new design was developed.

In some embodiments of the cold box, a new core is installed in the cold box and the cold box is put back on-line while a removed core is being repaired. This eliminates the need to have the manufacturer or supplier keep the unit off-line while the repair is being completed.

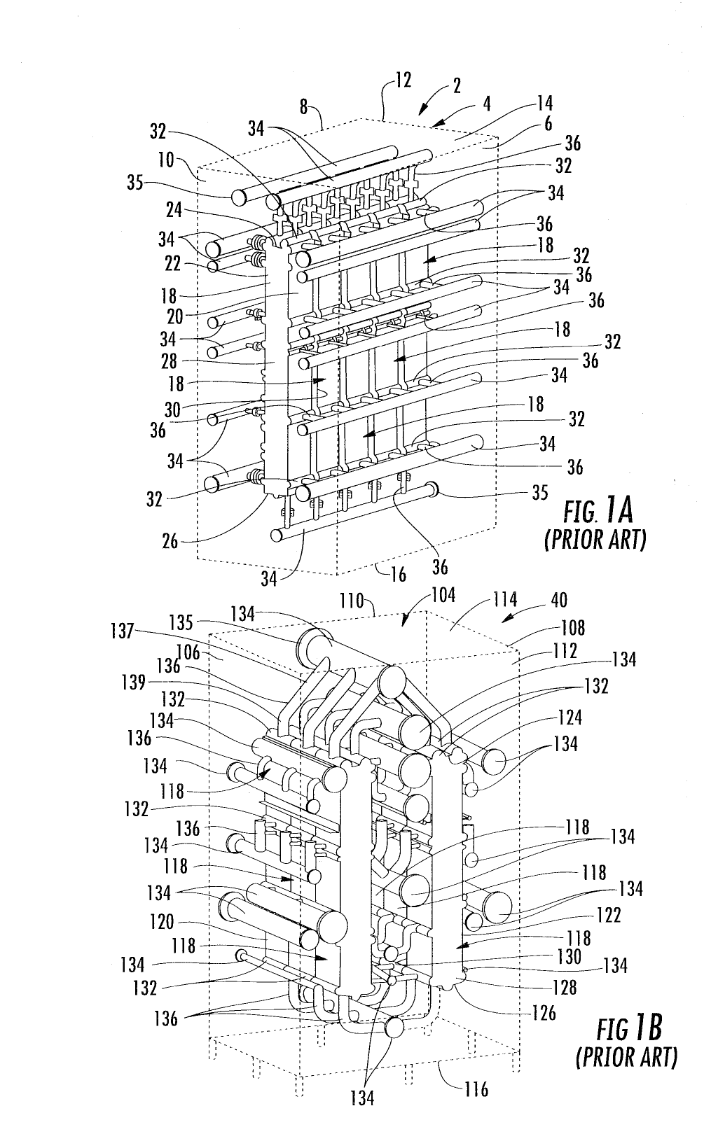

Referring to the drawings, FIGS. 1A and 1B represent preexisting designs for multi-core cold boxes. FIG. 1A represents a typical layout of a prior art design for a cold box design incorporating two to five cores. The specific example shown in FIG. 1A incorporates five cores.

As shown in FIG. 1A, the cold box 2 includes a housing 4 that may be of structural steel and is shown in phantom in the drawings. The housing 4 is generally rectangular and includes, for reference purposes, a front 6, back 8, two spaced sides 10 and 12, a top 14 and a bottom 16 that together constitute an enclosed structure.

Five cores 18 are positioned within the housing 4 in side-by-side relationship. These cores may be heat exchanger units. In the processing of natural gas and LNG, such heat exchanger units may be brazed aluminum plate fin heat exchangers.

As shown in FIG. 1A, each of the cores 18 is substantially rectangular in cross section, with a front surface 20, back surface 22, top surface 24, bottom surface 26 and two spaced side surfaces 28 and 30. The front surface 20, back surface 22, top surface 24 and bottom surface 26 have manifolds 32 mounted thereon that communicate with the interior of the core 18. (For the sake of clarity, not all of the manifolds 32 are numbered). These manifolds 32 extend generally parallel to the axis of the row of cores 18 and parallel to the front 6 and the back 8 of the housing.

The exact number and placement of the manifolds 32 on the front 20, back 22, top 24 and bottom 26 surfaces depend upon the particular cryogenic process being used and the particular design of the interior of the heat exchanger unit. The manifolds 32 provide a fluid path to the interior of the core at various interior locations of the core depending upon the particular design and purpose of the core.

Headers 34 are provided that extend parallel to the axis of the row of cores 18, with each header 34 extending in a plane parallel to the front 6 and back 8 of the housing 4, and parallel to the manifolds 32. These headers 34 extend through the sides 10, 12 of the cold box housing 4 and are adapted to be connected to conduits (not shown) provided on the outside of the cold box housing 4. For this purpose, the headers 34 may be provided with companion flanges 35 (not all have reference numerals) at their open ends for connection to a similar flange provided on a conduit outside of the cold box.

As shown in FIG. 1A, there are two headers 34 positioned above the top surfaces 24 of the cores, one header 34 positioned below the bottom surfaces 26 of the cores, six headers 34 in front of the front surfaces 20, and six headers 34 to the back of the back surfaces 22 of the cores 18.

The exact number of headers 34 depends upon the particular design and purpose of the cores. Individual feed lines 36 (only some of which are numbered), which are linear in shape, extend between each of the headers 34 and its respective manifold 32 on each of the individual heat exchangers to provide a connection for flow from the header 34 to the manifold 32. As an example, the headers 34 may be used to convey such liquids and gases to and from the heat exchanger units 18 as warm feed gas (natural gas+methane refrigerant recycle), feed gas going to high pressure LNG, warm high pressure N₂ refrigerant, boiloff gas being recirculated, cold low pressure N₂ refrigerant and cold low pressure methane refrigerant. The particular liquid or gas being conveyed by the headers depends upon the particular cryogenic process. The interior of the cold box housing 4 may be filled with an insulation material such as perlite (not shown).

FIG. 1B represents a typical layout of a prior art design for a cold box design incorporating six or more cores 118. The specific example shown in FIG. 1B incorporates six cores 118. Similar to the design of FIG. 1A, the cold box 40 includes a housing 104 that may be of structural steel and is shown in phantom in the drawing. The housing 104 includes a front 106, back 108, two spaced sides 110 and 112, a top 114 and a bottom 116 that together constitute an enclosed structure.

Within the housing are positioned six cores 118. As in the design of FIG. 1A, the cores 118 are substantially rectangular in cross section, with a front surface 120, back surface 122, top surface 124, bottom surface 126 and two spaced side surfaces 128 and 130. The cores 118 are arranged in two rows with three cores 118 in each row in side-by-side relationship. The front surface 120, back surface 122, top surface 124 and bottom surface 126 of the cores 118 have manifolds 132 thereon that communicate with the interior of the core 118. In the design of FIG. 1B, the rows are positioned parallel to each other. The cores 118 are arranged such that the manifolds 132 extend generally parallel to the axis of each row of cores 118 and parallel to the front 106 and back 108 of the housing.

Headers 134 are provided that extend parallel to the axis of the row of cores 118 and the manifolds 132, as well as the front 106 and the back 108 of the housing 104. These headers 134 extend through the sides 110, 112 of the cold box housing 104 and are adapted to be connected to conduits (not shown) provided on the outside of the cold box housing 104. For this purpose, the headers 134 may be provided with companion flanges 135 at their open ends for connection to a similar flange provided on a conduit outside of the cold box.

As shown in FIG. 1B there are six headers positioned between the front of each row of cores 118 and a side 106 or 108 of the housing 104 and also five headers 134 extending between the two rows of cores 118. There are two headers 134 provided above the cores 118 and one header 134 below the cores 118 in vertical alignment with the space between the rows. These headers 134 extend parallel to the manifolds 132 and parallel to the axis of the rows of cores 118.

Individual feed lines 136 (only some of which are numbered) extend between each of the headers 134 and its respective manifold 132 on each of the individual cores 118 to provide a connection for flow from the header 134 to the manifold 132. The feed lines 136 have a linear shape, are L-shaped, or have two straight sections 137, 139 joined to one another at an obtuse angle. The headers 134 may be provided with companion flanges at their open ends for connection to a companion flange provided on a conduit outside of the cold box. The interior of the cold box may be filled with an insulation material such as perlite.

In both the designs of FIGS. 1A and 1B there are headers 34 or 134 are positioned between the front and back of each the cores 18 or 118 and the front and back of the housing 4 or 104. Unless such headers 34 or 134 are disconnected and moved out of the way, a core 18 or 118 cannot be removed thought the front or back of the housing 4 or 104.

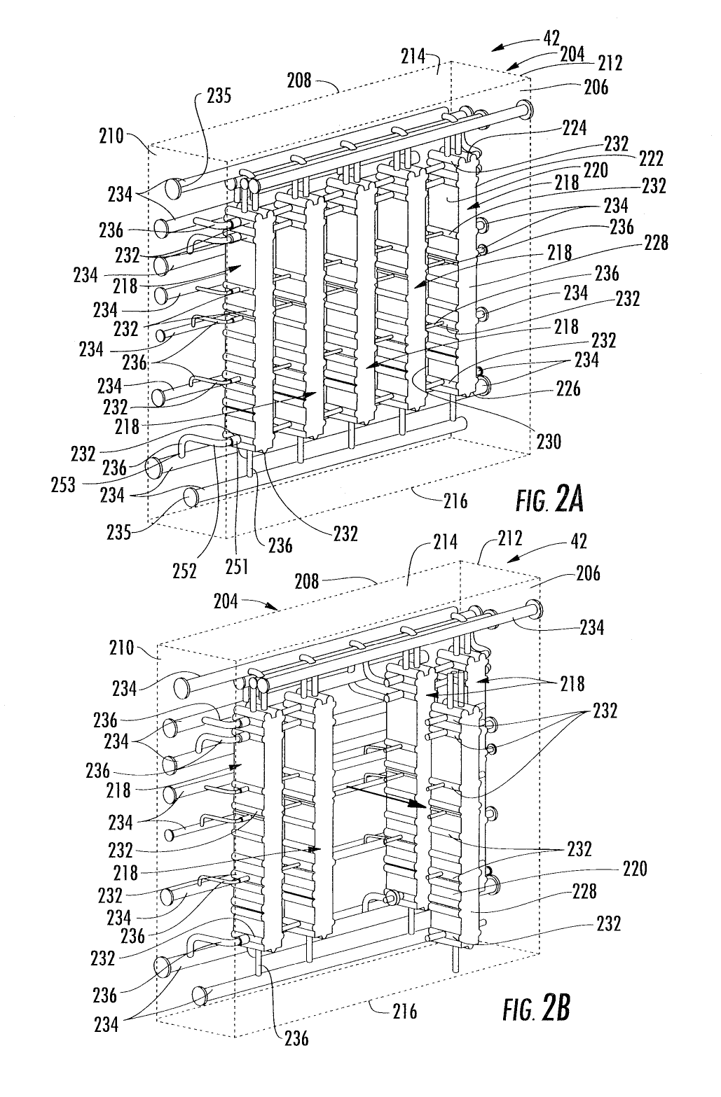

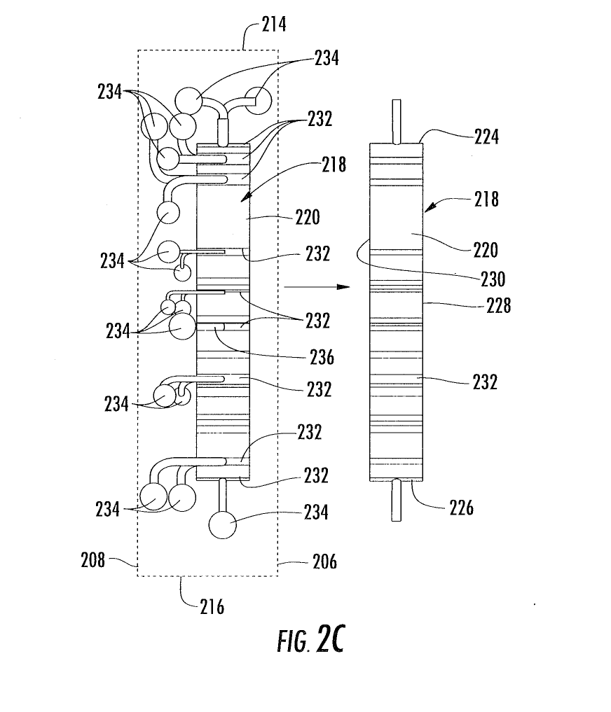

FIGS. 2A-2C show a cold box design according to the present disclosure that can be used for two up to five cores. These Figures show specifically five cores 218 mounted in a cold box 42. The cold box 42 includes a housing 204 that may be of structural steel and is shown in phantom in the drawings. The housing 204 is generally rectangular and includes for reference purposes a front 206, back 208, two spaced sides 210 and 212, a top 214 and a bottom 216 that together constitute an enclosed structure.

There are five cores 218 mounted in the housing 204. The cores 218 may be individual heat exchanger units, a non-limiting example of which is brazed aluminum plate fin heat exchangers. The cores 218 are substantially rectangular in cross section, and include, for reference purposes, a front surface 220, back surface 222, top surface 224, bottom surface 226 and spaced side surfaces 228 and 230. The five cores 218 are mounted in the housing 204 in a front-to-back relationship forming a single row along an axis extending from side to side in the housing 2. In the embodiment shown in FIGS. 2A-2C, the cores are spaced apart from one another. The cores 218 are mounted in the housing 204 with their front and back surfaces 220 and 222 facing the sides 210 and 212 respectively of the housing 204. Their side surfaces 228 face the front 206 of the housing 204 and their side surfaces 230 face the back 208 of the housing 204, respectively.

The front surface 220, back surface 222, top surface 224 and bottom surface 226 of each core in the design of FIGS. 2A-2C have manifolds 232 mounted thereon which communicate with the interior of the core 218. As shown in FIGS. 2A-2C, with the cores 218 positioned within the housing 204 as described, the manifolds 232 extend generally perpendicular to the axis of the row of cores 218 and parallel to the sides 210 and 212 of the housing 2.

Headers 234 are provided that extend parallel to the axis of the row of cores 218 with each extending in a plane parallel to the front 206 and back 208 of the housing 204. The headers 234 extend perpendicular to the manifolds 232. The headers 234 extend through the sides 210, 212 of the cold box housing 204 and are adapted to be connected to conduits (not shown) provided on the outside of the cold box housing 204. For this purpose, the headers 234 may be provided with companion flanges 235 at their open ends for connection to a similar flange provided on a conduit outside of the cold box.

As shown particularly in FIG. 2C, there are thirteen headers 234 positioned to the back side of the cores 218 between the cores 218 and the back 208 of the housing 202, while there are two headers 234 positioned above the cores 18 and one header positioned below the cores 218. There are no headers positioned in front of the cores 218 between the cores 218 and the front 206 of the housing. The exact number of headers 234 depends upon the particular design and purpose of the heat exchanger units.

Individual feed lines 236 (only some of which are numbered) extend between each of the headers 234 and its respective manifold 232 on each of the individual heat exchangers to provide a connection for flow from the header 234 to the manifold 232. In the embodiment shown in FIGS. 2A-2C, some of the feed lines 236 have a configuration that includes a first section 251 that is connected to a manifold 232 and extends in an X direction parallel to the axis of the row of cores 218, a second intermediate section 252 that is fluidly connected to the first section 251 and extends horizontally in a Z direction generally perpendicular to the axis of the row of cores 218, and a third section 253 that is fluidly connected to the intermediate section 252 and extends vertically in a Y direction perpendicular to the axis of the header 234 to which it is connected. As shown in FIGS. 2A and 2C, some of the feed lines have a curved shape that connects a manifold to a header that is perpendicular to the manifold. In some configurations (not shown), the first section of some of the feed lines extends horizontally in the X direction, the second intermediate section extends vertically in the Y direction, and the third section extends horizontally in the Z direction.

As mentioned previously, the headers 234 may be used to convey such liquids and gases to and from the heat exchanger units 218 as warm feed gas (natural gas+methane refrigerant recycle), feed gas going to high pressure LNG, warm high pressure N₂ refrigerant, boiloff gas being recirculated, cold low pressure N₂ refrigerant and cold low pressure methane refrigerant. The particular liquid or gas being conveyed by the headers depends upon the particular cryogenic process. When the cold box is in use, the free volume within the cold box may be filled with an insulation material such as perlite.

As described above, in the arrangement as shown in FIGS. 2A-2C, there are no headers 234 or feed lines 236 to the front of the front side surfaces 228 of the cores 218 between the front side surfaces 228 and the front 206 of the housing 204. In the event repair or replacement of a core 218 becomes necessary, a given core 218 can be easily removed by opening the front 206 of the housing 204, disconnecting the feed lines 236 to the desired core 218 and pulling the core 218 outwardly as shown in FIGS. 2B and 2C. There are no headers 234 blocking the removal as there would be in the examples shown in FIGS. 1A and 1B. The design provides substantial maintenance cost savings due to the ease of core access and repair, and the reduction of downtime required for repair or replacement of the cores. Furthermore, the ability to remove and replace cores, servicing cores in need of repair at a location other than on a floating platform, provides flexibility in servicing options for the heat exchange units. Another advantage is that the removal and replacement of a core can be performed by the ship's own maintenance crew. The removed core in need of repair can then be serviced by the manufacturer at a future date.

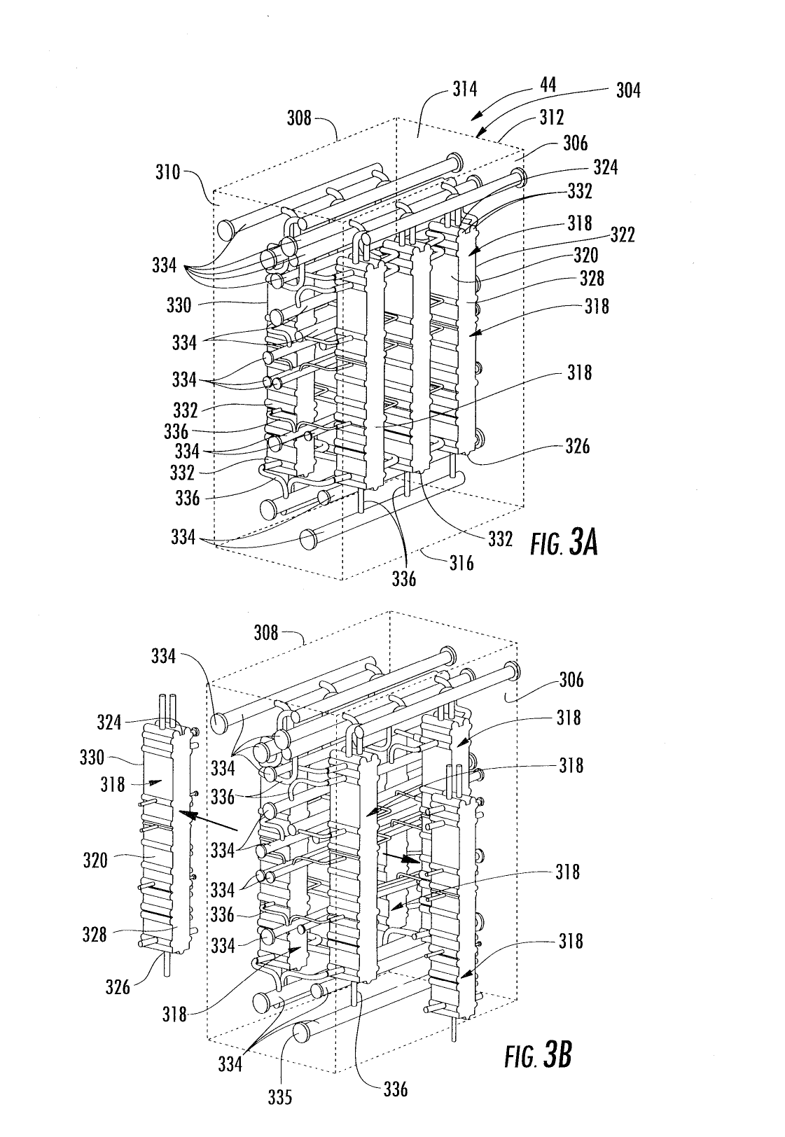

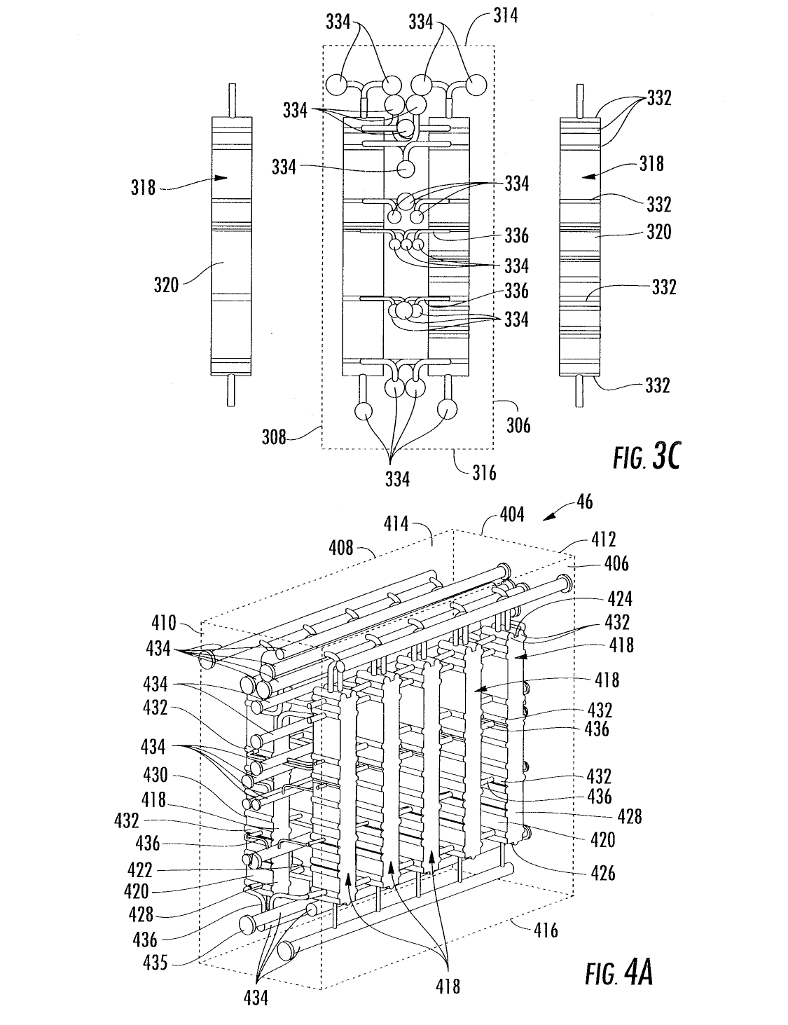

FIGS. 3A-3C show a design according to the present disclosure that can be used for six or more cores 318. These Figures show specifically six cores 318 mounted in the cold box 44. The cold box 44 includes a housing 304 that may be of structural steel and is shown in phantom in the drawings. The housing 304 is generally rectangular and includes for reference purposes a front 306, back 308, two spaced sides 310 and 312, a top 314 and a bottom 316 that together constitute an enclosed structure.

There are six cores 318 mounted in the housing 2. The cores 318 may be individual heat exchanger units, such as brazed aluminum plate fin heat exchangers. As in the previous designs, the cores 318 in FIGS. 3A-C are substantially rectangular in cross section, and include, for reference purposes, a front surface 320, back surface 322, top surface 324, bottom surface 326, a side surface 328 and a side surface 330. The six cores 318 are arranged in two parallel rows with three cores 318 in each row. The cores 318 in each row are in a front-to-back relationship. Each of the two rows extends along an axis extending from side to side in the housing 302. As such, the cores 318 are mounted in the housing 302 with their front and back surfaces 320 and 322 facing the sides 310 and 312 respectively of the housing 304 and their side surfaces 328 and 330 facing the front 306 and back 308 of the housing 304 respectively.

As with the cores 218 shown in FIGS. 2A 2C, the front surface 320, back surface 322, top surface 324 and bottom surface 326 of each core 318 in the design of FIGS. 3A-3C have manifolds 332 mounted thereon which communicate with the interior of the core 318. As shown in FIGS. 3A-3C, with the cores 318 positioned within the housing 304 as described, the manifolds 332 extend generally perpendicular to the axis of the rows of cores 18 and parallel to the sides 310 and 312 of the housing 304.

Headers 334 are provided that extend parallel to the axis of the row of cores 318 with each extending in a plane parallel to the front 306 and back 308 of the housing 304. The headers 334 extend perpendicular to the manifolds 332. These headers 334 extend through the cold box housing 304 and are adapted to be connected to conduits (not shown) provided on the outside of the cold box housing 304. For this purpose, the headers 334 may be provided with companion flanges 335 at their open ends for connection to a similar flange provided on a conduit outside of the cold box.

As shown particularly in FIG. 3C there are fifteen headers 334 extending in the space between the two rows of cores 318 while each row has two headers 334 extending along the row above the cores 318 and one header 318 extending along the rows below the cores. Individual feed lines 336 (only some of which are numbered) extend between each of the headers 334 and its respective manifold 332 on each of the cores 318 in a row to provide a connection for flow from the header 334 to the manifold 332. As with previous designs, in use the free volume within the cold box may be filled with an insulation material such as perlite.

With the arrangement shown in FIGS. 3A-3C there are no headers 334 positioned between the side 328 of the front row of cores 318 and the front 306 of the housing 304. There are also no headers 318 positioned between the side 330 of the back row of cores and the back 308 of the housing 304. If it becomes necessary to remove a core 318 for repair or replacement, the individual feed lines 336 to the given core can be disconnected and the core 318 pulled out through the front 306 or back 308 of the housing 4 depending upon the row in which the core 318 to be removed is located as shown in FIGS. 3B and 3C. There are no headers 334 blocking the removal.

In the embodiment shown in FIGS. 3A-3C, some of the feed lines 336 have a configuration that includes a first section 351 that is connected to a manifold 332 and extends in an X direction parallel to the axis of the row of cores 318, a second intermediate section 352 that is fluidly connected to the first section and extends horizontally in a Z direction generally perpendicular to the axis of the row of cores 318, and a third section 353 that is fluidly connected to the second section and extends vertically in a Y direction perpendicular to the axis of the header 334 to which it is connected. As shown in FIGS. 3A and 3C, some of the feed lines have a curved shape that connects the manifold to a header that is perpendicular to the manifold. In some configurations (not shown), the first section of some of the feed lines extends horizontally in the X direction, the second intermediate section extends vertically in the Y direction, and the third section extends horizontally in the Z direction.

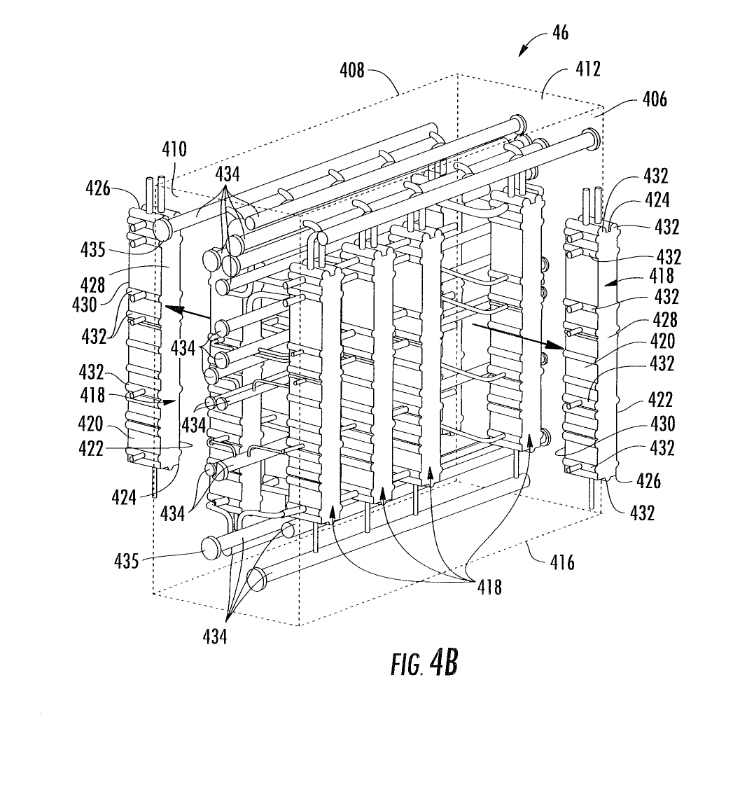

FIGS. 4A-4B show a design similar to FIGS. 3A-3C but showing ten cores 418 mounted in the cold box. The cold box 46 includes a housing 404 that may be of structural steel and is shown in phantom in the drawings. The housing 404 is generally rectangular and includes for reference purposes a front 406, back 408, two spaced sides 410 and 412, a top 414 and a bottom 416 that together constitute an enclosed structure.

There are ten cores 418 mounted in the housing 402. The cores 418 may be individual heat exchanger units, such as brazed aluminum plate fin heat exchangers. As in the previous designs, the cores 418 in FIGS. 4A-4C are substantially rectangular in cross section, and include, for reference purposes, a front surface 420, back surface 422, top surface 424, bottom surface 426 and two spaced side surfaces 428 and 430. The six cores 418 are arranged in two rows with five cores 418 in each row. The cores 418 in each row are in a front-to-back relationship. Each of the two rows extends along an axis extending from side to side in the housing 402. As such, the cores 418 are mounted in the housing 402 with their front and back surfaces 420 and 422 facing the sides 410 and 412 respectively of the housing 404 and their side surfaces 428 and 430 facing the front 406 and back 408 of the housing 404 respectively. If more cores are needed, they can be added to the end of each row.

The front surface 420, back surface 422, top surface 424 and bottom surface 426 of each core 418 in the design of FIGS. 4A-4B have manifolds 432 mounted thereon which communicate with the interior of the core 418. As shown in FIGS. 4A-4B, with the cores 418 positioned within the housing 402 as described, the manifolds 432 extend generally perpendicular to the axis of the rows of cores 418 and parallel to the sides 410 and 412 of the housing 402.

Headers 434 are provided that extend parallel to the axis of the row of cores 418 with each extending in a plane parallel to the front 406 and back 408 of the housing 404. The headers 434 extend perpendicular to the manifolds 432. The headers 434 extend through the side walls 410, 412 of the cold box housing 404 and are adapted to be connected to conduits (not shown) provided on the outside of the cold box housing 404. For this purpose, the headers 434 may be provided with companion flanges 435 at their open ends for connection to a similar flange provided on a conduit outside of the cold box.

As shown in FIG. 4A, there are fifteen headers 434 extending in the space between the two rows of cores 418 while each row has two headers 434 extending along the row above the cores 418 and one header 418 extending along the row below the cores. Individual feed lines 436 (only some of which are numbered) extend between each of the headers 434 and its respective manifold 432 on each of the cores 418 in a row to provide a connection for flow from the header 434 to the manifold 432. The feed lines may have configurations similar to those described in connection with FIGS. 3A-3C. As with previous designs, in use the free volume within the cold box may be filled with an insulating material such as perlite.

With the arrangement shown in FIGS. 4A-4C there are no headers 418 positioned between the front row of cores 418 and the front 406 of the housing 404 and no headers positioned between the back row of cores and the back 408 of the housing 404. If it becomes necessary to remove a core 418 for repair or replacement, the individual feed lines to the given core 418 can be disconnected and the core 418 pulled out through the front 406 or back 408 of the housing 404 depending upon the row in which the core 418 to be removed is located as shown in FIG. 4B. There are no headers 434 blocking the removal.

The heat exchange units comprising the cold boxes described herein are typically configured to operate in the pressure range of 1300 psig or more, usually about 1300 to about 1400 psig. The units typically have a minimum design operating temperature of −320° F. or less, or −300° F.

The new cold boxes described herein have a variety of uses, and, as mentioned above, are particularly well-suited for inclusion in natural gas heat exchanger units, including LNG and FLNG units. The units can be maintained efficiently due to the ease of removal and replacement of cores needing repair.

As indicated above, in embodiments, the size and/or weight of the cold box is increased as compared to the size and/or weight of a conventional system having generally the same capacity. In a typical cold box according to certain embodiments disclosed herein, the space between the cores will increase by about 10-50%, or about 25-50% as compared to a conventional system having the same capacity, resulting in certain circumstances in an overall increase in volume of the cold box of about 10-30%, or about 20-30%. In some cases, the configuration within the cold box will employ additional pipe fittings that may increase the weight of the cold box by about 5-20%, or about 10-20% as compared to a conventional cold box having the same capacity.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

1. A cold box including:
a. a housing providing an enclosed structure;
b. at least one set of a plurality of cores within the housing, each core having a front, back, top, bottom and side surface, the cores in each set positioned in a row in front-to-back relationship along an axis, the cores having a plurality of manifolds on their front and back sides;
c. a plurality of headers within the housing adapted to be connected to conduits outside of the housing, the headers extending parallel to the axis of the row of cores, the headers being positioned to the top, bottom and/or rear of the cores with the space between one side of all the cores and the housing being free from the headers; and
d. feed lines connecting each of the headers to a respective core.

2. The cold box of claim 1 wherein there are two sets of a plurality of heat exchange units within the housing and the headers are positioned above, below and between the two rows of cores with the space between one side of all the cores and the housing having no header positioned therein.

3. The cold box of claim 1 wherein each of the plurality of headers has a companion coupling at its open end.

4. The cold box of claim 1 wherein the cores comprise brazed aluminum heat exchangers.

5. The cold box of claim 1 wherein there is one set of cores forming a single row, the row having up to five cores.

6. The cold box of claim 1 wherein the manifolds extend perpendicular to the axis of the row in which the heat exchange units are positioned.

7. A cold box including:
a. a housing providing an enclosed structure including a front, back, two sides, a top and a bottom;
b. a plurality of cores having front, back, top, bottom and two spaced side surfaces within the housing positioned in a row in front-to-back relationship;
c. a plurality of manifolds on the front and back surfaces of each core;
d. a plurality of headers within the housing adapted to be connected to conduits outside of the housing, the headers extending parallel to the axis of the row of cores, the headers being positioned to the top, bottom and back of the cores with the space between the one side of the cores and the front of the housing being free from the headers; and
e. feed lines connecting each of the headers to a respective manifold on the cores.

8. The cold box of claim 7 wherein each of the manifolds extends perpendicular to the axis of the row in which the heat exchange units are positioned.

9. The cold box of claim 7 wherein the cores comprise heat exchanger units.

10. The cold box of claim 9 wherein the heat exchanger units comprise brazed aluminum heat exchangers.

11. The cold box of claim 7 wherein one side of each of the cores faces the front of the housing and the other side faces the back of the housing.

12. The cold box of claim 7 wherein the axis of the row extends from side to side in the housing.

13. The cold box of claim 7 wherein there are at least five cores in the row.

14. The cold box of claim 7 wherein the headers extend perpendicular to the manifolds.

15. A cold box including:
a. a housing providing an enclosed structure including a front, back, two sides, a top and a bottom:
b. a plurality of cores having front, top, bottom and two spaced side surfaces within the housing, the cores being positioned in two rows with the cores in each row being in front-to-back relationship;
c. a plurality of manifolds on the front and back surfaces of each core;
d. a plurality of headers within the housing adapted to be connected to conduits outside of the housing, the headers extending parallel to the axis of the row of cores, the headers of the plurality being positioned to the top, bottom and between the rows of cores heat exchange units with the space between one side of each of the cores and the housing being free from the headers; and
e. feed lines connecting each of the headers to a respective manifold on the cores.

16. The cold box of claim 14 wherein each of the manifolds extends perpendicular to the axis of the row in which the cores are positioned.

17. The cold box of claim 14 wherein the cores comprise heat exchanger units.

18. The cold box of claim 17 wherein the heat exchanger units comprise brazed aluminum heat exchangers.

19. The cold box of claim 14 wherein there are at least three cores in a row.

20. The cold box of claim 19 wherein there are at least five cores in a row.

21. The cold box of claim 15 wherein the cold box is disposed on a floating liquefied natural gas production unit.

22. A method of making a cold box, comprising:
obtaining a housing providing an enclosed structure with a removable side wall;
disposing at least one set of a plurality of cores within the housing, each core having a front, back, top, bottom and side surface, the cores in each set positioned in a row in front-to-back relationship along an axis, the cores having a plurality of manifolds on their front and back sides;
disposing a plurality of headers within the housing, the headers being configured to be connected to conduits outside of the housing, the headers extending parallel to the axis of the row of cores, the headers being positioned to the top, bottom and/or rear of the cores with the space between one side of all the cores and the housing being free from the headers; and
connecting each of the headers to a respective core using a feed line.

23. The method of claim 21, wherein each of the manifolds extends perpendicular to the axis of the row in which the cores are positioned.
